(19) United States
(12) Patent Application Publication
(10) Pub. No.: US 2016/0370770 A1
(43) Pub. Date: Dec. 22, 2016

(54) MONITORING SYSTEM AND ENGINEERING TOOL

(71) Applicant: AZBIL CORPORATION, Chiyoda-ku (JP)

(72) Inventor: Hiroshi MINE, Chiyoda-ku (JP)

(73) Assignee: AZBIL CORPORATION, Chiyoda-ku (JP)

(21) Appl. No.: 15/185,243

(22) Filed: Jun. 17, 2016

(30) Foreign Application Priority Data
Jun. 22, 2015 (JP) 2015-124853

(51) Int. Cl. G05B 13/02; G05B 15/02

(52) U.S. Cl. CPC G05B 13/0205; G05B 15/02

(57) ABSTRACT

To automate confirmation of a control program.

An engineering tool includes a data separating unit that separates data about an object registered in a control program from real data in a control device; a state changing unit that changes the state of the object, which is a detection source, in the control device after the separation of the data; a state acquiring unit that acquires the state of the object, which is a change destination, from the control device after the change of the state; a history acquiring unit that acquires history data concerning the control program from a monitoring device; and a confirming unit that compares results of the acquisition by the state acquiring unit and the history acquiring unit with a result of an arithmetic operation in a normal time of the control program to confirm the operation of the control program.

### CROSS-REFERENCE TO RELATED APPLICATIONS

The present application claims priority to Japanese Application No. 2015-124853, filed Jun. 22, 2015, the entire contents of which are incorporated herein by reference.

### FIELD

The present disclosure relates to an engineering tool automatically confirming the operation of a control program that varies the state of an object in a field control instrument, which is a change destination, in accordance with a change in the state of an object in a field control instrument, which is a detection source.

### 2. DESCRIPTION OF THE RELATED ART

Monitoring systems have hitherto been known, which monitor and control multiple field control instruments in structures, such as buildings (for example, refer to Japanese Unexamined Patent Application Publication No. 2014-013486). Various control programs including an event program and a mathematical operation exist in the monitoring systems. The event program is a control program that synchronizes the variation at a certain state point with an output from another start-stop point and is described also in Japanese Unexamined Patent Application Publication No. 2014-013486. The mathematical operation is a control program that supplies the results of arithmetic operations at multiple analog points to other analog points.

When a typical monitoring system is started to confirm the operations of the control programs, an operator varies data, which is an input of an arithmetic operation, for each program to confirm whether the result of the arithmetic operation is matched with the operation at an output point. There are problems in that it takes time to perform the confirmation, the load on the operator is increased, and a miss may occur.

In addition, when the control program that is set does not operate due to a failure or the like in the system while the building system is being operated, the control method that has been designed may not be realized to cause a complaint from a client.

### SUMMARY

Accordingly, it is an object of the disclosure to provide a monitoring system and an engineering tool capable of automating confirmation of a control program.

According to an embodiment, a monitoring system includes a control device configured to monitor and control instruments; a monitoring device configured to monitor and control the control device using a control program that varies a state of an object in the control instrument, which is a change destination, in accordance with a change in a state of an object in the control instrument, which is a detection source; and an engineering tool configured to confirm an operation of the control program. The engineering tool comprising processing circuitry configured to (a) separate data about an object registered in the control program from real data in the control device, (b) change the state of the object, which has been registered in the control program and which is the detection source, in the control device after separating data is terminated, (c) acquire the state of the object, which has been registered in the control program and which is the change destination, from the control device after changing the state of the object unit is terminated, (d) acquire history data concerning the control program from the monitoring device, and compare results of the acquisition with a result of an arithmetic operation in a normal time of the control program to confirm the operation of the control program.

### BRIEF DESCRIPTION OF THE DRAWINGS

FIG. 1 illustrates an exemplary configuration of a monitoring system according to an embodiment of the present disclosure;

FIG. 2 is a block diagram illustrating an exemplary configuration of an engineering tool according to the embodiment of the present disclosure, which is involved in an automatic confirmation function of a control program;

FIG. 3 is a flowchart illustrating an exemplary automatic confirmation operation of the control program by the engineering tool according to the embodiment of the present disclosure;

FIG. 4 illustrates the exemplary automatic confirmation operation of the control program by the engineering tool according to the embodiment of the present disclosure;

FIG. 5 illustrates exemplary conditions of an event program in the embodiment of the present disclosure;

FIG. 6 illustrates exemplary definitions of input objects and output objects in the embodiment of the present disclosure;

FIG. 7 illustrates exemplary operations for the input objects from the engineering tool according to the embodiment of the present disclosure and exemplary expected states of the output objects; and

FIG. 8 illustrates examples of determination of the operation of an event program by the engineering tool according to the embodiment of the present disclosure.

### DETAILED DESCRIPTION

Embodiments of the present disclosure will herein be described in detail with reference to the attached drawings.

### One Embodiment

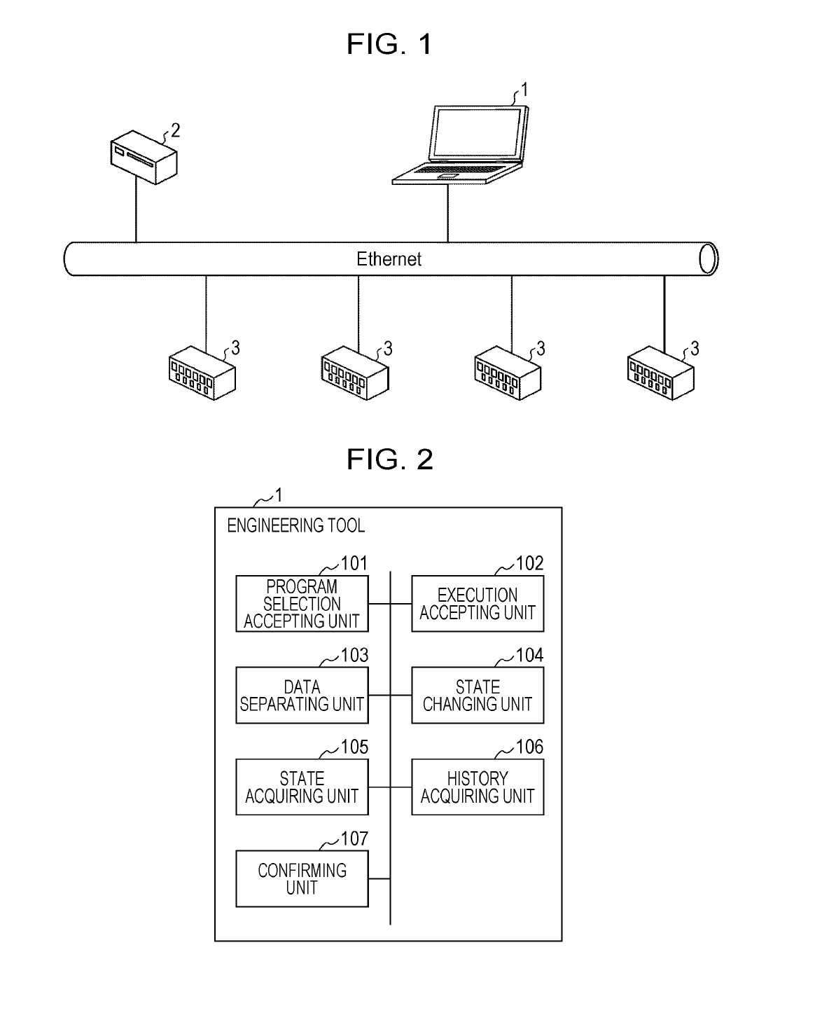

FIG. 1 illustrates an exemplary configuration of a monitoring system according to an embodiment of the present disclosure.

Referring to FIG. 1, the monitoring system includes an engineering tool 1, a monitoring device 2, and control devices 3.

The engineering tool 1 is used to build the monitoring system. The engineering tool 1 supports, for example, an open standardized communication protocol, such as BACnet, and communicates with the control devices 3 according to this communication protocol. In addition, the engineering tool 1 performs automatic confirmation of a control program described below. The configuration of the engineering tool 1, which is involved in the automatic confirmation function of the control program, will be described below.

The monitoring device 2 monitors and controls the multiple control devices 3 connected according to the communication protocol described above. The monitoring device 2 controls the control devices 3 using the control program.

The control devices 3 monitor and control multiple lower-level controllers (not illustrated) under the control of the monitoring device 2. Field control instruments (control instruments) (not illustrated) are connected to the lower-level controllers. The field control instruments monitor and control the states, the values, and so on of objects.

The configuration of the engineering tool 1, which is involved in the automatic confirmation function of the control program, will now be described with reference to FIG. 2.

The control program is an arithmetic function of the monitoring system. Specifically, the control program is a function to vary the state of a field control instrument, which is a change destination, in accordance with the result of an arithmetic operation using a change in the state of an object in a field control instrument, which is a detection source, as an input. The engineering tool 1 performs the automatic confirmation of the control program using a manual override function of the control device 3 and history data in the monitoring device 2. The manual override function means a function to separate data in the control device 3 from real data to set the control device 3 to a state in which arbitrary data is capable of being written.

Referring to FIG. 2, the engineering tool 1 includes a program selection accepting unit 101, an execution accepting unit 102, a data separating unit 103, a state changing unit 104, a state acquiring unit 105, a history acquiring unit 106, and a confirming unit 107.

The program selection accepting unit 101 accepts a control program to be confirmed, which has been selected by an operator, among the control programs set in the engineering tool 1.

The execution accepting unit 102 accepts a start time of the operation confirmation or an instruction to (immediately) start the operation confirmation, which is set by the operator.

The data separating unit 103 separates data about an object registered in the control program to be confirmed from real data in the control device 3 after the start time accepted by the execution accepting unit 102 or after the start instruction has been accepted from the execution accepting unit 102. When a period of collecting data from the control device 3 by the monitoring device 2 is related to the confirmation of the operation of the control program, the period of collecting data about the object separated from the real data by the monitoring device 2 is changed to one second.

In addition, the data separating unit 103 returns the state in which the data about the corresponding object is separated from the real data to the original state in the control device 3 after processing involved in the control program by the state acquiring unit 105 is terminated. When the data collecting period by the monitoring device 2 is also changed, the data collecting period is also returned to the original state.

The state changing unit 104 changes the state of the object, which has been registered in the control program to be confirmed and which is the detection source, in the control device 3 after the processing by the data separating unit 103 is terminated.

The state acquiring unit 105 acquires the state of the object, which has been registered in the control program to be confirmed and which is the change destination, from the control device 3 after the processing by the state changing unit 104 is terminated.

The history acquiring unit 106 acquires the history data concerning the control program to be confirmed from the monitoring device 2. Here, the history acquiring unit 106 acquires, for example, a display history of a virtual printer, as the history data.

The confirming unit 107 compares the results of the acquisition by the state acquiring unit 105 and the history acquiring unit 106 with the result of an arithmetic operation in a normal time of the control program to confirm the operation of the control program.

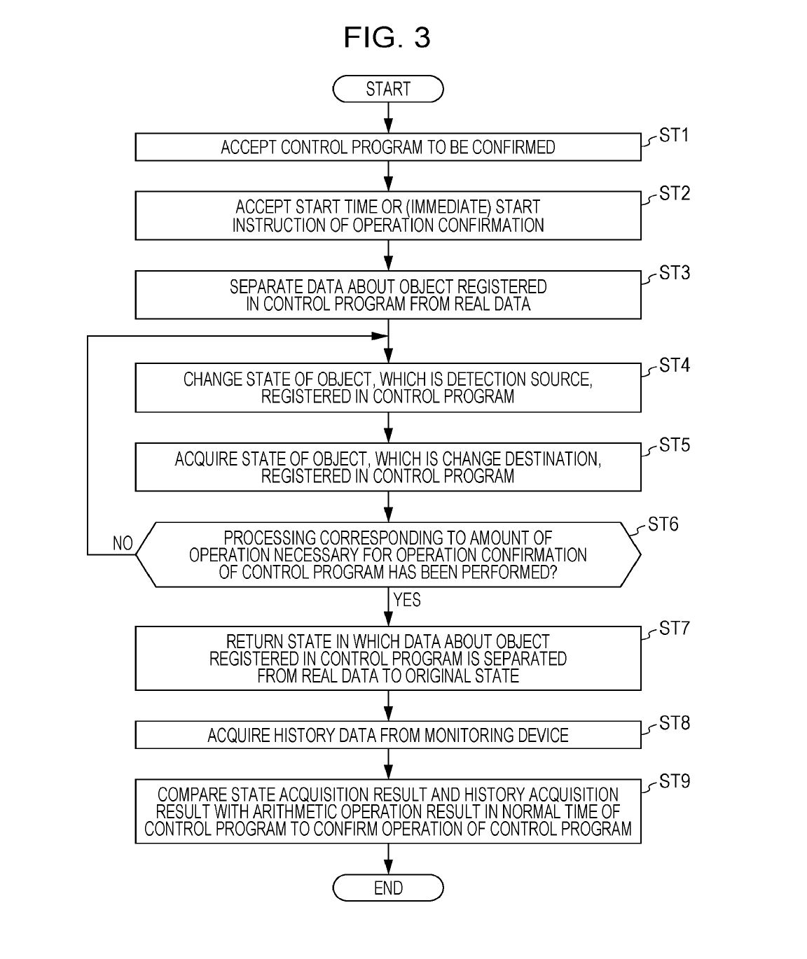

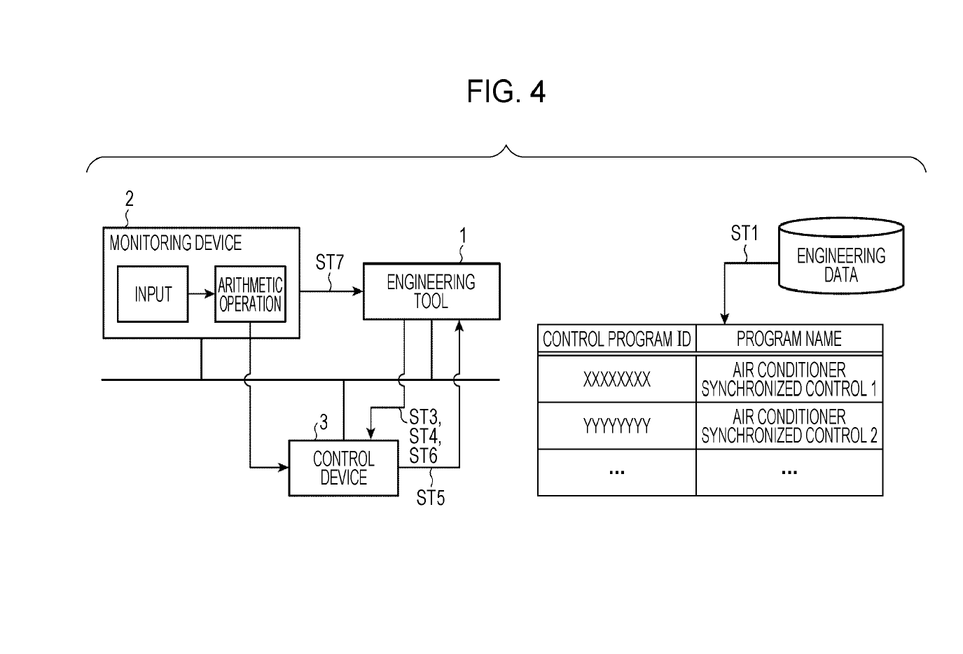

An example of the automatic confirmation operation of the control program in the engineering tool 1 configured in the above manner will now be described with reference to FIG. 3 and FIG. 4.

As illustrated in FIG. 3 and FIG. 4, in the automatic confirmation operation in the engineering tool 1, in Step ST1, the program selection accepting unit 101 accepts a control program to be confirmed, which has been selected by the operator, among the control programs set in engineering data in the engineering tool 1.

In Step ST2, the execution accepting unit 102 accepts the start time of the operation confirmation or the instruction to (immediately) start the operation confirmation, which is set by the operator.

In Step ST3, the data separating unit 103 separates data about an object registered in the control program to be confirmed from real data in the control device 3 after the start time accepted by the execution accepting unit 102 or after the start instruction has been accepted from the execution accepting unit 102. When the period of collecting data from the control device 3 by the monitoring device 2 is related to the confirmation of the operation of the control program, the period of collecting data about the object separated from the real data by the monitoring device 2 is changed to one second.

In Step ST4, the state changing unit 104 changes the state of the object, which has been registered in the control program to be confirmed and which is the detection source, in the control device 3 after the processing by the data separating unit 103 is terminated.

In Step ST5, the state acquiring unit 105 acquires the state of the object, which has been registered in the control program to be confirmed and which is the change destination, from the control device 3 after the processing by the state changing unit 104 is terminated.

In Step ST6, it is determined whether the processing corresponding to the amount of operation necessary for the confirmation of the operation of the control program has been performed. If the processing corresponding to the amount of operation necessary for the confirmation of the operation of the control program has not been performed (NO in Step ST6), Step ST4 and Step ST5 are repeated.

In Step ST7, the data separating unit 103 returns the state in which the data about the object registered in the control program is separated from the real data to the original state in the control device 3. When the data collecting period by the monitoring device 2 is also changed, the data collecting period is also returned to the original state.

Then, Step ST3 to Step ST7 are sequentially repeated for all of the control programs accepted in Step ST1.

In Step ST8, the history acquiring unit 106 acquires, for example, a display history of a virtual printer, as the history data from the monitoring device 2.

In Step ST9, the confirming unit 107 compares the results of the acquisition by the state acquiring unit 105 and the history acquiring unit 106 with the result of the arithmetic operation in the normal time of the control program to confirm the operation of the control program.

Although the control program to be confirmed is accepted by the program selection accepting unit 101 in the above automatic confirmation operation, the operation is not limited to the above method. For example, all of the control programs in the engineering data may be automatically confirmed.

Specific examples of the automatic confirmation of the control program will now be described. First, a specific example of the automatic confirmation of the event program will be described.

A case is described as the event program, in which the state of an air conditioner in a building is automatically synchronized with the state of a light in the building.

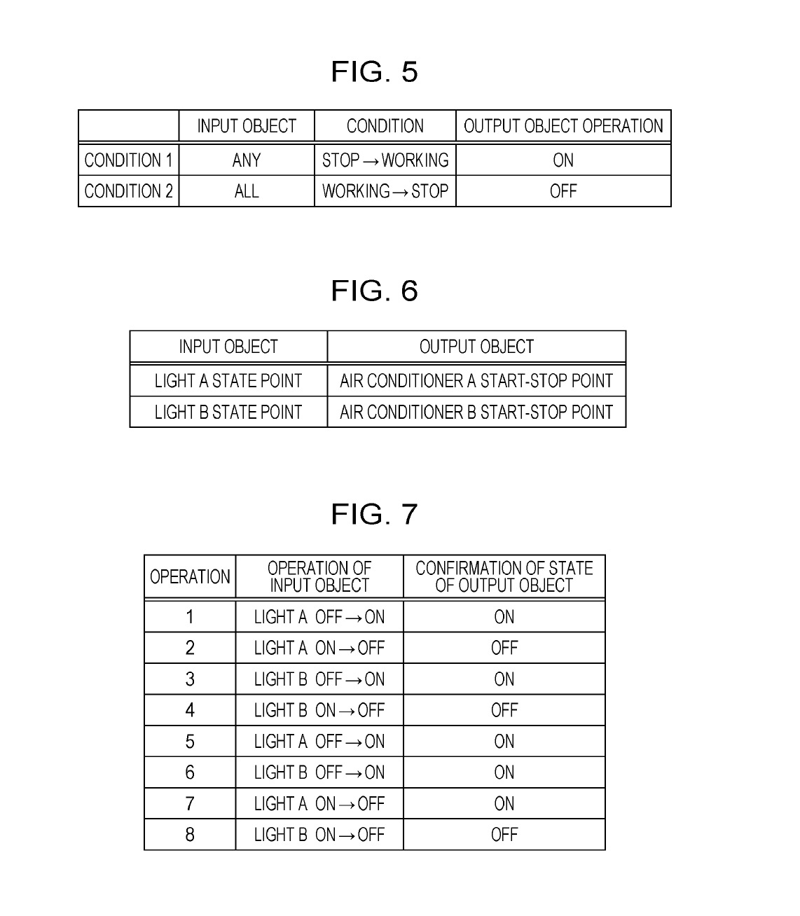

For example, state points of multiple lights are set as input objects (objects in the field control instrument, which is the detection source) and a start-stop point of an air conditioner is set as an output object (an object in the field control instrument, which is the change destination). It is assumed that conditions illustrated in FIG. 5 are set as the conditions of arithmetic operations of the control program. In this case, when any of the input objects is changed from a stop state to a working state, the control program outputs ON for the output object. When all of the input objects are changed from the working state to the stop state, the control program outputs OFF for the output object.

In addition, objects illustrated FIG. 6 are set as the input objects and the output objects.

In this case, operations illustrated in FIG. 7 are performed in Step ST4 and Step ST5 described above and the arithmetic operation of the control program is performed to acquire the state of the object, which is the corresponding change destination, from the control device 3. Then, after all of the operations are terminated, the history data is acquired from the monitoring device 2.

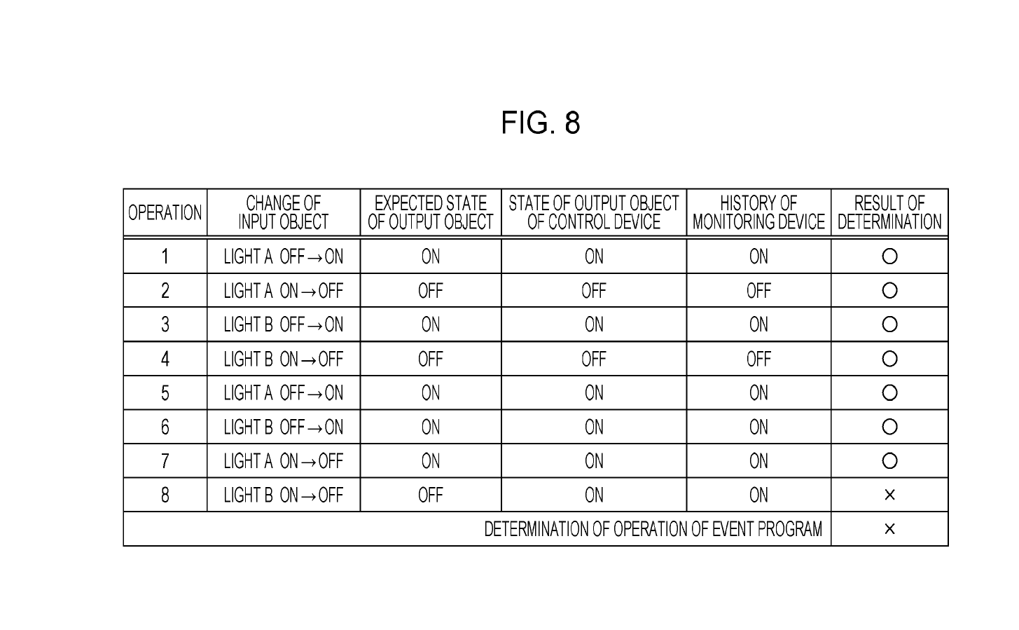

Whether the control program normally works is determined by confirming whether the state of the object, which is acquired from the control device 3 and which is the change destination, and the history data acquired from the monitoring device 2 are changed to expected states illustrated in FIG. 8.

In the operation confirmation when the operations illustrated in FIG. 7 have been performed, as illustrated in FIG. 8, each operation is determined to be a good operation if the object output from the control device 3 and the history data from the monitoring device 2 are in the expected states. In contrast, each operation is determined to be a bad operation if the object output from the control device 3 and the history data from the monitoring device 2 are different from the expected states.

In the confirmation of the operation of the event program, it is determined to be good if all of the operations are in the expected states and it is determined to be bad if any of the operations is the bad operation.

Next, a specific example of the automatic confirmation of the mathematical operation will be described.

The mathematical operation is a function to perform four arithmetic operations for integrated values or measured values and supply the result of the arithmetic operations to the output object. For example, when “Object A×Object B” is set as the mathematical operation and Object C is set as the output object, Object C has a value resulting from multiplication of the value of Object A by the value of Object B.

In this case, whether the control program normally works is determined by changing the value of the object of the arithmetic operation source (detection source) from the engineering tool 1, acquiring the data about the output object, and confirming whether the data has the expected value.

As described above, according to the above embodiment, since the engineering tool 1 includes the data separating unit 103 that separates data about an object registered in the control program from real data in the control device 3; the state changing unit 104 that changes the state of the object, which has been registered in the control program and which is the detection source, in the control device 3 after the processing by the data separating unit 103 is terminated; the state acquiring unit 105 that acquires the state of the object, which has been registered in the control program and which is the change destination, from the control device 3 after the processing by the state changing unit 104 is terminated; the history acquiring unit 106 that acquires the history data concerning the control program from the monitoring device 2; and the confirming unit 107 that compares the results of the acquisition by the state acquiring unit 105 and the history acquiring unit 106 with the result of the arithmetic operation in the normal time of the control program to confirm the operation of the control program, it is possible to automatically confirm the control program. Accordingly, the control program is capable of being confirmed in a short time. As a result, it is possible to reduce the load on the operator and to improve the quality of the system.

While the disclosure is described in terms of some specific examples and embodiment, it will be clear that this disclosure is not limited to these specific examples and embodiment and that many changes and modified embodiments will be obvious to those skilled in the art without departing from the true spirit and scope of the disclosure.

What is claimed is:

1. A monitoring system comprising:
a control device configured to monitor and control control instruments;
a monitoring device configured to monitor and control the control device using a control program that varies a state of an object in the control instrument, which is a change destination, in accordance with a change in a state of an object in the control instrument, which is a detection source; and
an engineering tool configured to confirm an operation of the control program,
wherein the engineering tool includes
processing circuitry configured to
separate data about an object registered in the control program from real data in the control device,
change the state of the object, which has been registered in the control program and which is the detection source, in the control device after separating data is terminated,
acquire the state of the object, which has been registered in the control program and which is the change destination, from the control device after changing the state of the object is terminated,
acquire history data concerning the control program from the monitoring device, and
compare results of the acquisition with a result of an arithmetic operation in a normal time of the control program to confirm the operation of the control program.

2. An engineering tool confirming an operation of a control program used in a monitoring device configured to monitor and control a control device configured to monitor and control instruments, the control program varying a state of an object in the control instrument, which is a change destination, in accordance with a change in a state of an object in the control instrument, which is a detection source, the engineering tool comprising:
processing circuitry configured to
separate data about an object registered in the control program from real data in the control device;
change the state of the object, which has been registered in the control program and which is the detection source, in the control device after separating the data is terminated;
acquire the state of the object, which has been registered in the control program and which is the change destination, from the control device after changing the state of the object is terminated;
acquire history data concerning the control program from the monitoring device; and
compare results of the acquisition with a result of an arithmetic operation in a normal time of the control program to confirm the operation of the control program.
